(19) United States
(12) Patent Application Publication
(10) Pub. No.: US 2018/0231954 A1
(43) Pub. Date: Aug. 16, 2018

(54) APPARATUS AND METHOD SUPPORTING AN INTERACTIVE CHAT FEATURE FOR RELAYING ON-DEMAND INFORMATION TO A USER FROM AN INDUSTRIAL PROCESS CONTROL AND AUTOMATION SYSTEM

(71) Applicant: Honeywell International Inc., Morris Plains, NJ (US)

(72) Inventor: Shane W. Booker, Tokyo (JP)

(21) Appl. No.: 15/822,296

(22) Filed: Nov. 27, 2017

Related U.S. Application Data
(60) Provisional application No. 62/458,865, filed on Feb. 14, 2017.

(51) Int. Cl. G05B 19/409; G05B 19/418; G06F 17/27

(52) U.S. Cl. CPC G05B 19/409; G05B 2219/23386; G06F 17/271; G05B 19/4185

(57) ABSTRACT

A method includes receiving a text message from a client device. The text message contains a request for information related to an industrial process control and automation system. The method also includes parsing the text message to identify the information being requested. The method further includes transmitting one or more queries for the information being requested and obtaining the information being requested. In addition, the method includes generating a natural-language response containing the information being requested and transmitting the natural-language response for delivery to the client device. The one or more queries could include at least one query to a historian associated with the control and automation system. The request for information could include a request for one or more values of one or more process variables associated with the control and automation system or a request for information identifying a status of specific equipment in the control and automation system.

### CROSS-REFERENCE TO RELATED APPLICATION AND PRIORITY CLAIM

This application claims priority under 35 U.S.C. § 119(e) to U.S. Provisional Patent Application No. 62/458,865 filed on Feb. 14, 2017. This provisional application is hereby incorporated by reference in its entirety.

### TECHNICAL FIELD

This disclosure relates generally to industrial process control and automation systems. More specifically, this disclosure relates to an apparatus and method supporting an interactive chat feature for relaying on-demand information to a user from an industrial process control and automation system.

### BACKGROUND

Industrial process control and automation systems are routinely formed using a large number of devices, such as sensors, actuators, and controllers. The controllers are often arranged hierarchically in a control and automation system. For example, lower-level controllers are often used to receive measurements from the sensors and perform process control operations to generate control signals for the actuators. Higher-level controllers are often used to perform higher-level functions, such as planning, scheduling, and optimization operations.

“Lean” manufacturing generally refers to a systematic approach for reducing or eliminating waste in a manufacturing process. For facilities that are operating lean manufacturing execution strategies or other strategies, the communication of ad hoc or other requests for information can become an overhead and a burden for operational staff. For instance, requests for information can disrupt and distract operators, who should be focused on controlling an industrial process and its related equipment.

### SUMMARY

This disclosure provides an apparatus and method supporting an interactive chat feature for relaying on-demand information to a user from an industrial process control and automation system.

In a first embodiment, an apparatus includes at least one interface configured to receive a text message from a client device, where the text message contains a request for information related to an industrial process control and automation system. The apparatus also includes at least one processing device configured to parse the text message to identify the information being requested, transmit one or more queries for the information being requested, obtain the information being requested, and generate a natural-language response containing the information being requested. The at least one interface is further configured to transmit the natural-language response for delivery to the client device.

In a second embodiment, a method includes receiving a text message from a client device, where the text message contains a request for information related to an industrial process control and automation system. The method also includes parsing the text message to identify the information being requested. The method further includes transmitting one or more queries for the information being requested and obtaining the information being requested. In addition, the method includes generating a natural-language response containing the information being requested and transmitting the natural-language response for delivery to the client device.

In a third embodiment, a non-transitory computer readable medium contains instructions that, when executed by at least one processing device, cause the at least one processing device to receive a text message from a client device. The text message contains a request for information related to an industrial process control and automation system. The medium also contains instructions that when executed cause the at least one processing device to parse the text message to identify the information being requested. The medium further contains instructions that when executed cause the at least one processing device to initiate transmission of one or more queries for the information being requested and obtain the information being requested. In addition, the medium contains instructions that when executed cause the at least one processing device to generate a natural-language response containing the information being requested and initiate transmission of the natural-language response for delivery to the client device.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates an example system supporting an interactive chat feature for relaying on-demand information to a user from an industrial process control and automation system according to this disclosure;

FIG. 3 illustrates example uses of an interactive chat feature for relaying on-demand information to a user from an industrial process control and automation system according to this disclosure;

FIG. 4 illustrates an example interactive chat session for relaying on-demand information to a user from an industrial process control and automation system according to this disclosure;

FIGS. 5 and 6 illustrate example devices supporting an interactive chat feature for relaying on-demand information to a user from an industrial process control and automation system according to this disclosure; and

FIGS. 7 and 8 illustrate example methods for supporting an interactive chat feature for relaying on-demand information to a user from an industrial process control and automation system according to this disclosure.

### DETAILED DESCRIPTION

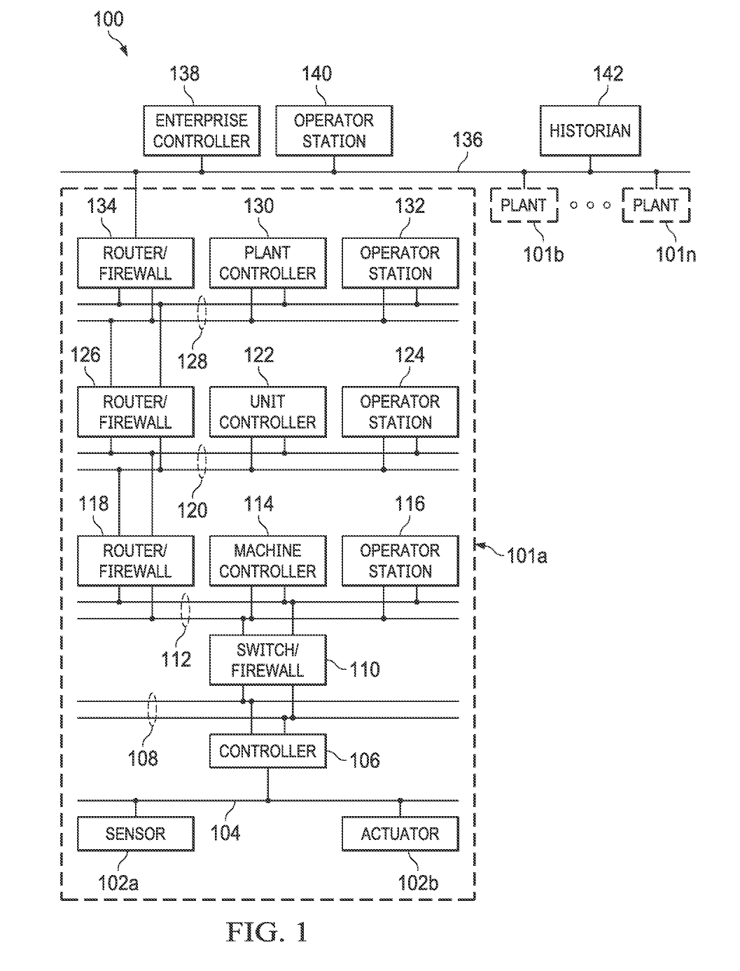

FIGS. 1 through 8, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

One or more networks 104 are coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” includes one or more controllers 106, which are coupled to the network 104. Among other things, each controller 106 may use the measurements from one or more sensors 102a to control the operation of one or more actuators 102b. Each controller 106 includes any suitable structure for controlling one or more aspects of a process system. As a particular example, each controller 106 could represent a computing device running a real-time operating system or other operating system.

Redundant networks 108 are coupled to the controllers 106. The networks 108 facilitate interaction with the controllers 106, such as by transporting data to and from the controllers 106. The networks 108 could represent any suitable redundant networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system or other operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system or other operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as a pair of Ethernet networks or an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system or other operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system or other operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as a pair of Ethernet networks or an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system or other operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system or other operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system or other operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system or other operating system.

A historian 142 is also coupled to the network 136 in this example. The historian 142 could represent a component that stores various information about the system 100. The historian 142 could, for example, store information used during production scheduling and optimization. The historian 142 represents any suitable structure for storing and facilitating retrieval of information. Although shown as a single centralized component coupled to the network 136, the historian 142 could be located elsewhere in the system 100, or multiple historians could be distributed in different locations in the system 100.

As noted above, the communication of ad hoc or other requests for information can become an overhead and a burden for operational staff associated with an industrial control and automation system. For example, personnel associated with the system 100 may need to know information about the system 100 or the underlying industrial process(es) being controlled. As particular examples, the personnel may need information about values of one or more process variables, whether specific equipment is active, the status of specific equipment, or what alarms (if any) are currently active. Asking human operators for this information can disrupt and distract the operators, who might otherwise be focusing their efforts on controlling the industrial process and the related equipment.

As described in more detail below, the system 100 can be integrated with or used in conjunction with a network-based communication tool, namely a text-based chat tool. When added to an industrial control domain, such a network-based communication tool could revolutionize the way personnel interact with industrial control and automation systems. Among other things, this approach allows ad hoc questions to be answered very quickly or instantly in a natural language format with no interactions with other personnel. Popular devices (such as smartphones like APPLE IPHONES and ANDROID phones) and apps (such as SKYPE, FACEBOOK MESSENGER, LINE, SLACK, WHATSAPP, or ALEXA) can be utilized to drive high adoption rates with little or no training. End users who need information associated with the system 100 could gain rapid access to that information at virtually any time. This can also reduce the burden on human operators and support leaner operating requirements. Additional details regarding these techniques are provided below.

Although FIG. 1 illustrates one example of an industrial process control and automation system 100, various changes may be made to FIG. 1. For example, a control and automation system could include any number of sensors, actuators, controllers, servers, operator stations, networks, and other components. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates one example environment in which chat-based interactions with users can be supported. This functionality can be used in any other suitable system.

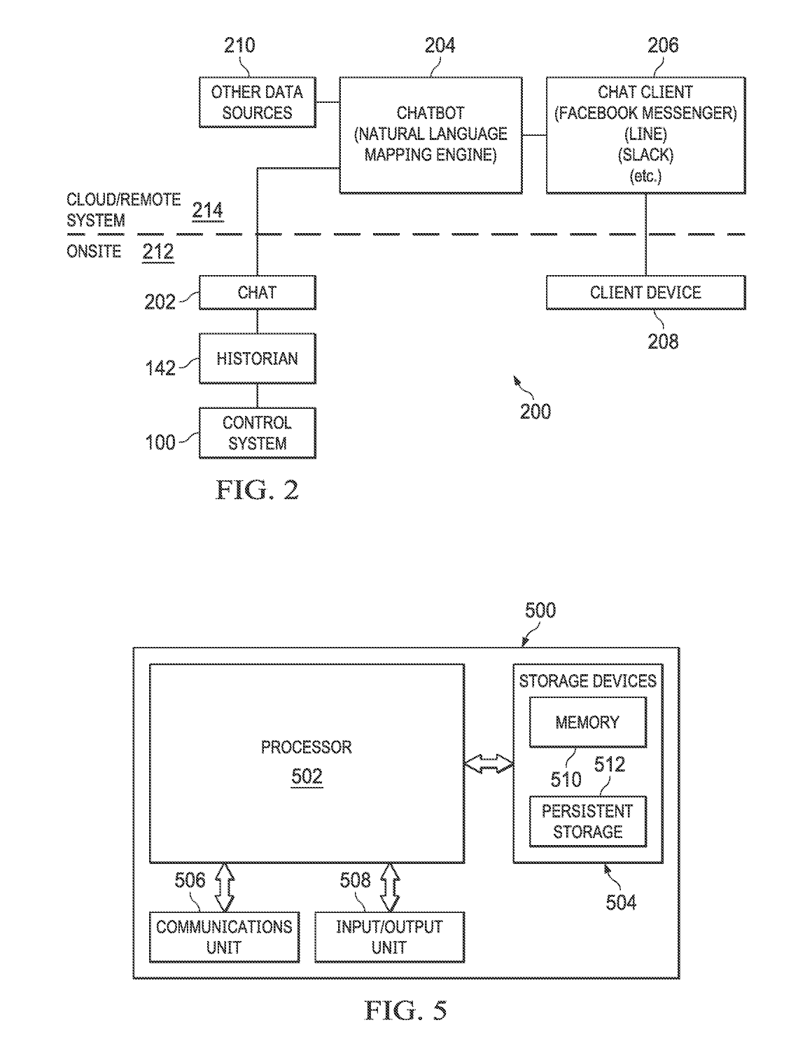

FIG. 2 illustrates an example system 200 supporting an interactive chat feature for relaying on-demand information to a user from an industrial process control and automation system according to this disclosure. For ease of explanation, the system 200 is described as being used in conjunction with the industrial process control and automation system 100 of FIG. 1. However, the system 200 could be used with any other suitable control or automation system.

As shown in FIG. 2, the system 200 includes or operates in conjunction with the control and automation system 100, along with at least one historian 142. Although the historian 142 is shown here as being separate from the control and automation system 100, this need not be the case. Also, note that similar connections could be used to obtain data from other data sources in the control and automation system 100, such as from one or more of the controllers 106, 114, 122, 130, 138. As a particular example, one or more Object Linking and Embedding (OLE) for Process Control (OPC) connections could be used to obtain information from at least one HONEYWELL EXPERION server or other data source.

The system 200 also includes a chat support application 202, which interacts with a mapping engine 204 (also referred to as a “chat bot”). The application 202 supports the transmission or reception of data to or from the historian 142 and the control and automation system 100. For example, the application 202 could be used to retrieve specific data values from the historian 142 or the system 100 for presentation to various personnel who are using chat-based tools. As specific examples, the application 202 could be used to retrieve values of specific process variables, such as different temperature, pressure, flow rate, or product output values. The application 202 could also be used to receive indications whether specific equipment is active or what the status or conditions of the specific equipment are. In addition, the application 202 could be used to receive alarms that are currently active and to summarize the alarms or output the alarms.

The chat support application 202 includes any suitable logic for interacting with one or more components associated with a control and automation system to obtain data. For example, the application 202 could denote one or more software routines that are executed by a computing device. In particular embodiments, various components associated with the control and automation system 100 (such as the historian 142) could have standard or proprietary interfaces, such as one or more application programming interfaces (APIs). The chat support application 202 can be configured to interact with those components via their interfaces in order to obtain data.

The chat bot or mapping engine 204 receives text-based communications from and sends text-based communications to one or more chat clients 206. For incoming text-based communications received from a chat client 206, the mapping engine 204 can parse the text in the communications and identify what data is being requested by personnel. The mapping engine 204 can then request the appropriate data, such as from the support application 202. For outgoing text-based communications sent from the chat client 206, the mapping engine 204 can generate text messages containing requested data and pass the messages to the chat client(s) 206 for delivery to one or more client devices 208.

The following are specific examples of the types of incoming messages that could be received by the mapping engine 204. These are examples only and do not limit the usage of the chat-based communications described here. Examples of incoming messages can include:

“What is the output of the system today?”

“What is the temperature in tank #1?”

“What is the level in reactor #3?”

“What is the pressure in tank #7?”

“Alarms?”

“Are there any alarms for tank #1?”

“Email me the production report.”

The mapping engine 204 can parse each of these messages and identify specific data that a user is requesting. For example, the mapping engine 204 can use terms like “the system,” “tank #1,” “reactor #3,” and “tank #7” to identify a specific piece of equipment or a specific collection of equipment associated with an incoming message. The mapping engine 204 could also use terms such as “output,” “temperature,” “level,” and “pressure” to identify one or more specific data values associated with that piece of equipment or collection of equipment. The mapping engine 204 could further use terms such as “alarms” and “production report” to recognize a query for specific information that may relate to a piece of equipment, a collection of equipment, or the overall system. In addition, the mapping engine 204 could use terms such as “what” or “email” to determine how a user wishes to receive a response. The mapping engine 204 could then issue one or more queries for the appropriate data (such as to the application 202) and perform a requested function.

The mapping engine 204 includes any suitable logic for mapping language in order to identify requests for information and generate suitable responses. For example, the mapping engine 204 could denote one or more software routines that are executed by a computing device. Various natural language mapping engines and chat bots are known in the art. In some embodiments, since the mapping engine 204 is designed for use with an industrial control and automation system, information defining expected types of information requests and suitable responses can be used by the mapping engine 204 when parsing incoming messages and generating outgoing messages. This information could generally define the syntax and grammar that the mapping engine 204 expects to be used in incoming messages and that the mapping engine 204 uses to generate outgoing messages.

Each chat client 206 denotes any suitable device or system that interacts with client devices via text-based communications. In some embodiments, the chat client(s) 206 could denote one or more third-party systems that are not owned or operated by the owners or operators of the industrial control and automation system 100. Specific examples of chat clients 206 could include SKYPE, FACEBOOK MESSENGER, LINE, SLACK, WHATSAPP, or ALEXA.

The client devices 208 denote portable or other devices used by end users who wish to engage in chat-based communications and receive data associated with the control and automation system 100. The client devices 208 could execute chat, messaging, or other applications that support the exchange of text-based communications. As particular examples, the client devices 208 could include desktop computers, laptop computers, tablet computers (such as APPLE IPAD or ANDROID devices), or smartphones (such as APPLE IPHONE or ANDROID devices).

Note that the mapping engine 204 here is not limited to obtaining data only from the historian 142 or the control and automation system 100. The mapping engine 204 could also or alternatively obtain data from one or more other data sources 210. Any suitable data sources 210 could be used here. As a particular example, a data source 210 could denote a knowledge database that stores information related to the control and automation system 100, such as information relevant to repair or maintenance of process equipment. The mapping engine 204 could access this data source 210 to provide information to users in order to assist in repairs or maintenance. As another particular example, the data source 210 could contain information associated with predictions related to the control and automation system 100, such as predictions related to equipment conditions or predictions related to when equipment might fail. The mapping engine 204 could access this data source 210 to provide information to users to support various support, repair, or maintenance operations.

In one aspect of operation, a user of a client device 208 could initiate a text-based communication (such as a text message) requesting specific information related to the control and automation system 100. The chat client 206 receives the communication and forwards the communication to the mapping engine 204. The mapping engine 204 analyzes the communication in order to identify the requested information. The mapping engine 204 could also verify whether the user or the client device 208 is authorized to request such information. Assuming the request is proper, the mapping engine 204 interacts with the support application 202 to retrieve the requested information (such as from the historian 142 or other component of the control and automation system 100) or with the other data sources 210 to retrieve the requested information. The mapping engine 204 generates a suitable text-based response (such as another text message) containing the requested information and forwards the response to the chat client 206, which delivers the response to the client device 208. This process can occur any number of times to support different information requests from the client device 208. This process could also occur with any number of client devices 208.

In some embodiments, a client device 208 can execute a chat, messaging, or other application that supports the use of contacts, and the mapping engine 204 could be identified as a contact in the client device 208. When a user wishes to engage in text-based communications involving the mapping engine 204, the user could initiate a communication to the contact associated with the mapping engine 204. In particular embodiments, a Quick Response (QR) code or other optical code could be used to provide information to the client device 208 in order to create a contact. However, other approaches for defining contacts could also be used.

Moreover, in some embodiments, a client device 208 can execute a chat, messaging, or other application that supports the use of user authentication. A user of the client device 208 could provide authentication credentials (such as a username and password) to the application, which can use the authentication credentials to validate the user with the mapping engine 204 or the support application 202. This can help to reduce or prevent unauthorized users from obtaining data via the text-based communications.

In FIG. 2, the various components are shown as residing in different domains 212 and 214. The domain 212 denotes at least one onsite or local domain and represents at least one industrial site at which the control and automation system 100 is being used. The domain 214 denotes at least one remote domain, such as a cloud-based domain or a remote system domain, where the mapping engine 204 and the chat client 206 are executed. Note, however, that the division shown in FIG. 2 is for illustration only and that other embodiments could also be used. For instance, the historian 142 and/or the support application 202 could reside in the domain 214. As another example, at least one data source 210 could reside in the domain 212.

There are a number of potential uses or applications for this chat-based technology as it relates to industrial process control and automation systems. The following denotes example use cases, but other uses of this technology are supported.

Rapid Responses for Ad Hoc Queries—The mapping engine 204 can receive queries for data and provide rapid responses to those queries. This may reduce or eliminate the need for personnel to ask control room operators for data, which can allow the control room operators to focus more of their efforts on process control. This is particularly useful for people outside of a control room who need data.

Digital Technician for Troubleshooting—The mapping engine 204 can interact with a user to guide the user through repair or maintenance for a piece of equipment. The mapping engine 204 may have access to process data and a knowledge database, so the mapping engine 204 can guide a technician in a repair or maintenance operation.

Integration with Prediction Services/Systems—Various services or systems can be used to analyze process data and make predictions about an industrial process, such as by predicting the potential for equipment failures. These services or systems also often make recommendations or provide advice on how to respond to potential failures or other issues. One specific example of this is the HONEYWELL UOP CONNECTED PERFORMANCE SERVICES (CPS). The mapping engine 204 can query such prediction services or systems in order to provide predictions and advice to users.

Although FIG. 2 illustrates one example of a system 200 supporting an interactive chat feature for relaying on-demand information to a user from an industrial process control and automation system, various changes may be made to FIG. 2. For example, the system 200 could include any number of control and automation systems, historians, support applications, mapping engines, chat clients, client devices, data sources, and domains. Also, various components shown in FIG. 2 could be combined, further subdivided, omitted, or rearranged and additional components could be added according to particular needs. In addition, while particular functions have been described as being performed by particular components of the system 200, this is for illustration only and could change as needed or desired.

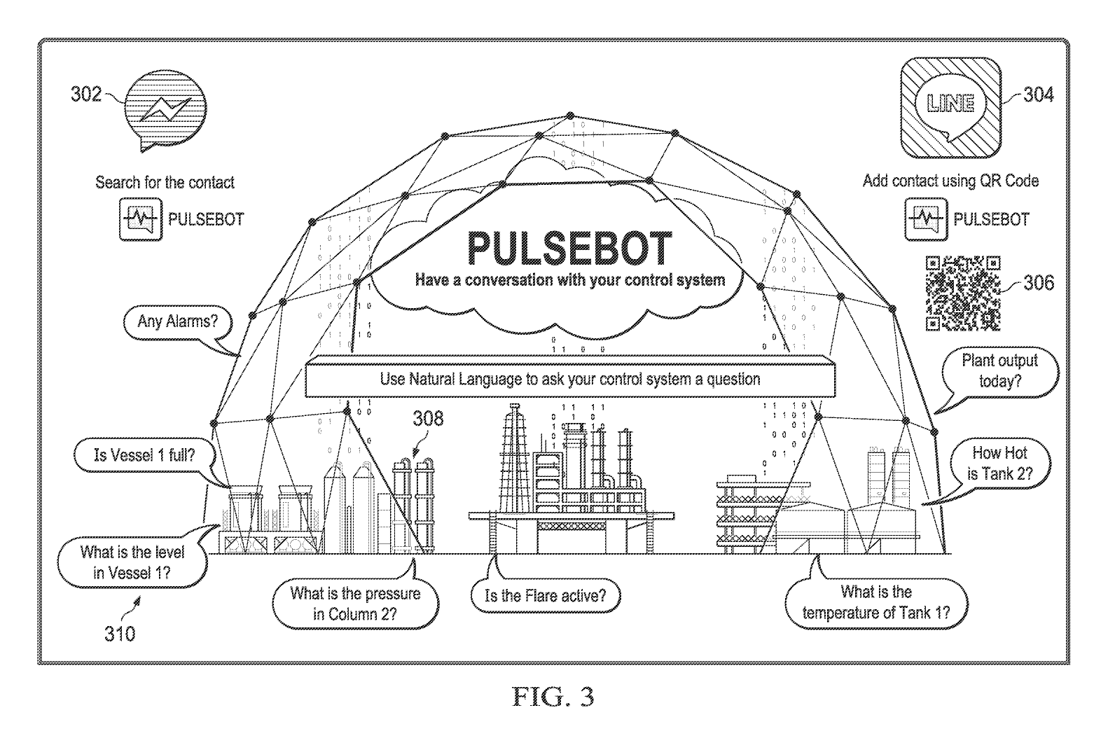

FIG. 3 illustrates example uses of an interactive chat feature for relaying on-demand information to a user from an industrial process control and automation system according to this disclosure. In the example shown in FIG. 3, the mapping engine 204 is referred to by the name PULSEBOT, and the client devices 208 execute at least one app that allows text-based communications with the mapping engine 204. Here, the apps include FACEBOOK MESSENGER and LINE, although other or additional apps could also be supported. The FACEBOOK MESSENGER app 302 could allow a user to search for a contact that identifies the mapping engine 204, and the LINE app 304 could allow a user to scan a QR code 306 that identifies the mapping engine 204.

Various types of example interactions are also shown in FIG. 3. For example, FIG. 3 identifies one or more sites 308 containing industrial equipment and various text-based queries 310 that could involve the industrial equipment at those sites 308. As noted above, each query 310 could be provided from a client device 208 to the mapping engine 204 via a chat client 206, and the mapping engine 204 can parse the query 310 to identify the specific equipment or collection of equipment associated with the query 310 and the specific data being requested. The mapping engine 204 can then obtain the requested data, generate at least one text-based response, and send the response back to the client device 208 via the chat client 206.

Although FIG. 3 illustrates examples of uses of an interactive chat feature for relaying on-demand information to a user from an industrial process control and automation system, various changes may be made to FIG. 3. For example, other or additional apps could be used by the client devices 208, and contacts could be located or added in any other or additional manner. Also, the queries 308 and industrial equipment shown in FIG. 3 are examples only.

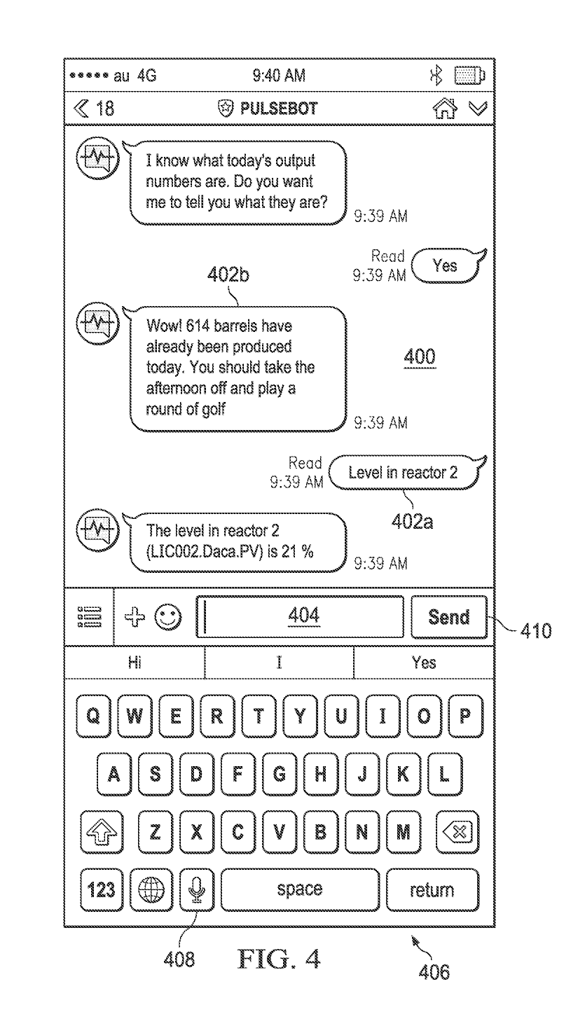

FIG. 4 illustrates an example interactive chat session for relaying on-demand information to a user from an industrial process control and automation system according to this disclosure. The chat session here occurs using one of the client devices 208, and a screen 400 of the client devices 208 contains various text-based messages 402a-402b. The messages 402a denote messages from a user, and the messages 402b denote messages from the mapping engine 204. As can be seen here, the user's messages 402a can request specific information, and the mapping engine's messages 402b can provide the requested information.

The mapping engine 204 could also ask if the user wishes to receive specific information in one or more messages 402b, and the user can respond in one or more messages 402a indicating whether that specific information should be provided. If so, the mapping engine 204 can generate one or more additional messages 402b containing the information. The mapping engine 204 can use any suitable logic in deciding whether to ask if a user wishes to retrieve specific information and what information might be offered to the user. For instance, the mapping engine 204 could determine that a user typically asks for specific data at specific times, such as data related to an overall system (or part thereof) at the beginning of the user's work shift, and the mapping engine 204 could offer to provide the same information at the start of the user's current work shift. The mapping engine 204 could also use the user's scope of responsibility (such as one or more areas being managed or overseen by the user in a plant) and ask whether the user wishes to receive specific data within that scope of responsibility. Any other or additional approaches could be used to select data that a user might wish to receive.

The screen 400 also presents a text area 404. The user could tap the text area 404 and type a message for the mapping engine 204 using a keyboard 406. The user could also or alternatively tap a microphone icon 408 and speak a message for the mapping engine 204. Speech recognition supported by the client device 208 could be used to convert the speech into text, and the text could be shown in the text area 404. However entered, a “send” button 410 can be used to send a text message to the mapping engine 204.

In some embodiments, chat sessions like the one shown in FIG. 4 can occur using any client devices 208 that execute a specified application and that authenticate an authorized user. Also, access controls could be used by the mapping engine 204, the support application 202, the data sources 210, the historian 142, or the control and automation system 100 to limit the type of data that a particular user might be able to obtain.

Although FIG. 4 illustrates one example of an interactive chat session for relaying on-demand information to a user from an industrial process control and automation system, various changes may be made to FIG. 4. For example, the messages shown in FIG. 4 are examples only. Also, while the example embodiment in FIG. 4 shows an interactive chat session that could occur involving an interface provided by an APPLE IPHONE, other devices could also be used during an interactive chat session.

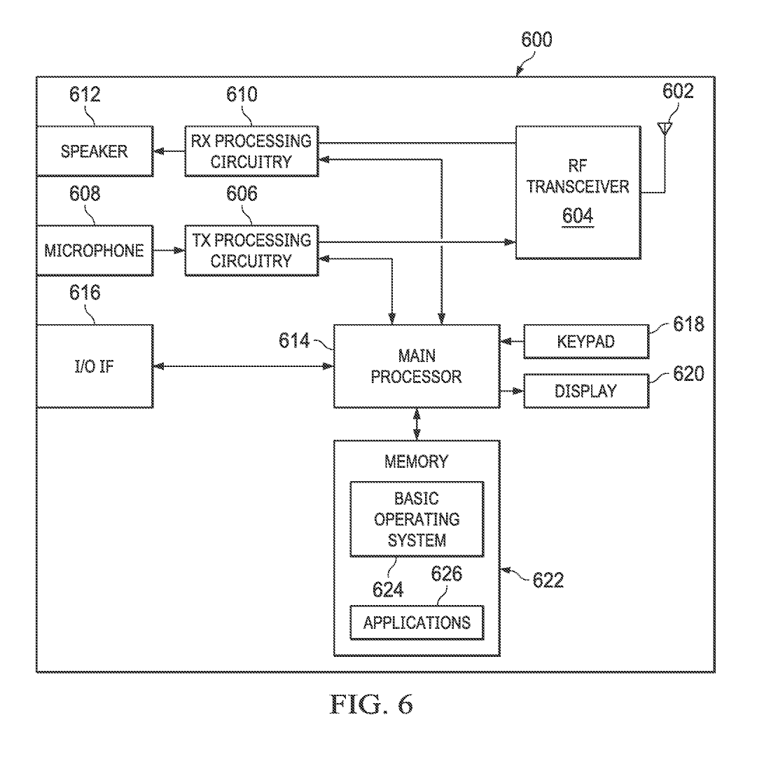

FIGS. 5 and 6 illustrate example devices supporting an interactive chat feature for relaying on-demand information to a user from an industrial process control and automation system according to this disclosure. In particular, FIG. 5 illustrates an example device 500 that could execute or provide the support application 202, the mapping engine 204, or the chat client 206. The device 500 could also represent a client device 208, such as a desktop or laptop computer. FIG. 6 illustrates an example mobile device 600 that could represent a client device 208.

As shown in FIG. 5, the device 500 includes at least one processor 502, at least one storage device 504, at least one communications unit 506, and at least one input/output (I/O) unit 508. Each processor 502 can execute instructions, such as those that may be loaded into a memory 510. Each processor 502 denotes any suitable processing device, such as one or more microprocessors, microcontrollers, digital signal processors, application specific integrated circuits (ASICs), field programmable gate arrays (FPGAs), or discrete circuitry.

The memory 510 and a persistent storage 512 are examples of storage devices 504, which represent any structure(s) capable of storing and facilitating retrieval of information (such as data, program code, and/or other suitable information on a temporary or permanent basis). The memory 510 may represent a random access memory or any other suitable volatile or non-volatile storage device(s). The persistent storage 512 may contain one or more components or devices supporting longer-term storage of data, such as a read only memory, hard drive, Flash memory, or optical disc.

The communications unit 506 supports communications with other systems or devices, such as the support application 202, the mapping engine 204, the chat clients 206, the client devices 208, or the data sources 210. For example, the communications unit 506 could include at least one network interface card or wireless transceiver facilitating communications over at least one wired or wireless network. The communications unit 506 may support communications through any suitable physical or wireless communication link(s).

The I/O unit 508 allows for input and output of data. For example, the I/O unit 508 may provide a connection for user input through a keyboard, mouse, keypad, touchscreen, or other suitable input device. The I/O unit 508 may also send output to a display, printer, or other suitable output device.

As shown in FIG. 6, the mobile device 600 includes an antenna 602, a radio frequency (RF) transceiver 604, transmit (TX) processing circuitry 606, a microphone 608, and receive (RX) processing circuitry 610. The mobile device 600 also includes a speaker 612, a main processor 614, an input/output (I/O) interface (IF) 616, a keypad 618, a display 620, and a memory 622. The memory 622 includes a basic operating system (OS) program 624 and one or more applications 626.

The RF transceiver 604 receives, from the antenna 602, an incoming RF signal, such as a cellular or WiFi signal. The RF transceiver 604 down-converts the incoming RF signal to generate an intermediate frequency or baseband signal. The intermediate frequency or baseband signal is sent to the RX processing circuitry 610, which generates a processed baseband signal by filtering, decoding, and/or digitizing the baseband or intermediate frequency signal. The RX processing circuitry 610 transmits the processed baseband signal to the speaker 612 (such as for voice data) or to the main processor 614 for further processing (such as for chat data).

The TX processing circuitry 606 receives analog or digital voice data from the microphone 608 or other outgoing baseband data (such as chat data) from the main processor 614. The TX processing circuitry 606 encodes, multiplexes, and/or digitizes the outgoing baseband data to generate a processed baseband or intermediate frequency signal. The RF transceiver 604 receives the outgoing processed baseband or intermediate frequency signal from the TX processing circuitry 606 and up-converts the baseband or intermediate frequency signal to an RF signal that is transmitted via the antenna 602.

The main processor 614 can include one or more processors or other processing devices and execute the basic OS program 624 stored in the memory 622 in order to control the overall operation of the mobile device 600. For example, the main processor 614 could control the reception of forward channel signals and the transmission of reverse channel signals by the RF transceiver 604, the RX processing circuitry 610, and the TX processing circuitry 606 in accordance with well-known principles. In some embodiments, the main processor 614 includes at least one microprocessor or microcontroller.

The main processor 614 is also capable of executing other processes and applications 626 resident in the memory 622. The main processor 614 can move data into or out of the memory 622 as required by an executing application 626. The main processor 614 is also coupled to the I/O interface 616, which provides the mobile device 600 with the ability to connect to other devices such as laptop computers and handheld computers. The I/O interface 616 is the communication path between these accessories and the main processor 614.

The main processor 614 is also coupled to the keypad 618 and the display 620. The operator of the mobile device 600 can use the keypad 618 to enter data into the mobile device 600. The display 620 may be a liquid crystal display or other display capable of rendering text and/or at least limited graphics, such as from web sites. Note that if the display 620 denotes a touch screen capable of receiving input, fewer or no buttons or keypads may be needed.

The memory 622 is coupled to the main processor 614. Part of the memory 622 could include a random access memory (RAM), and another part of the memory 622 could include a Flash memory or other read-only memory (ROM).

Although FIGS. 5 and 6 illustrate examples of devices supporting an interactive chat feature for relaying on-demand information to a user from an industrial process control and automation system, various changes may be made to FIGS. 5 and 6. For example, various components in each figure could be combined, further subdivided, or omitted and additional components could be added according to particular needs. As a particular example, each processor 502 or 614 could be divided into multiple processors, such as one or more central processing units (CPUs) and one or more graphics processing units (GPUs). Also, computing and mobile devices come in a wide variety of configurations, and FIGS. 5 and 6 do not limit this disclosure to any particular computing device or mobile device.

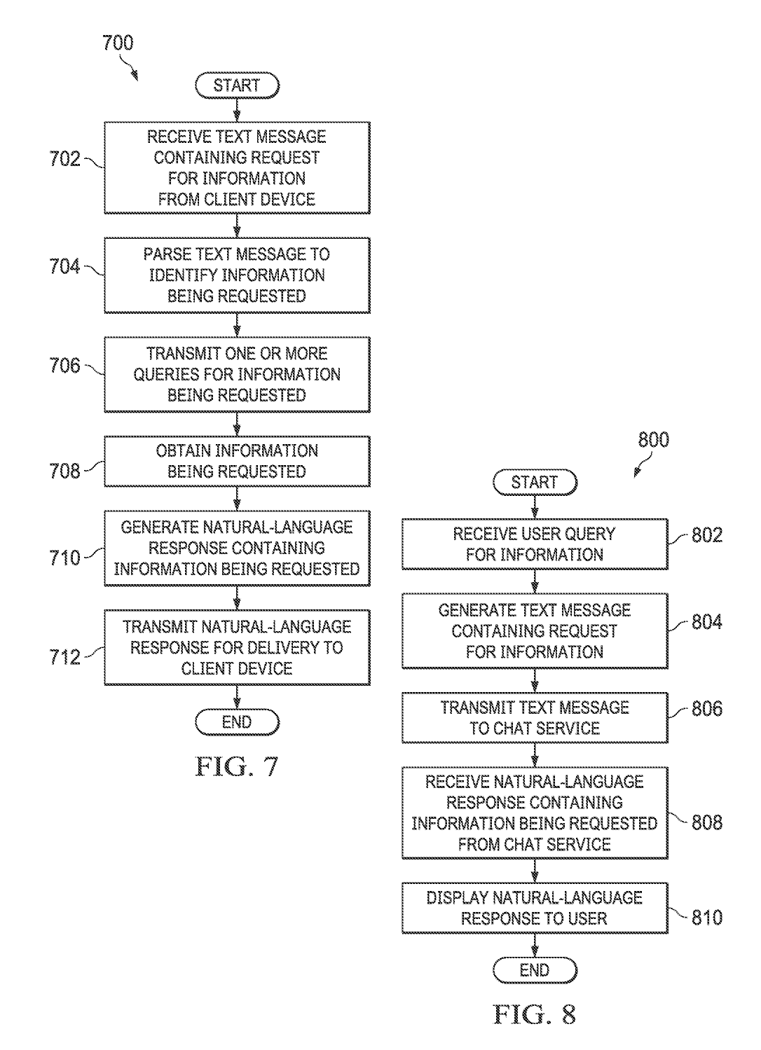

FIGS. 7 and 8 illustrate example methods for supporting an interactive chat feature for relaying on-demand information to a user from an industrial process control and automation system according to this disclosure. In particular, FIG. 7 illustrates an example method 700 that could be performed using a mapping engine 204 to interact with a user via text-based communications, and FIG. 8 illustrates an example method 800 that could be performed using a client device 208 to support interactions with the mapping engine 204. For ease of explanation, the method 700 is described as involving the use of the device 500 in FIG. 5, and the method 800 is described as involving the use of the device 600 in FIG. 6. However, each method 700 and 800 could involve the use of any other suitable device, and those devices could be used in any suitable system.

As shown in FIG. 7, a text message containing a request for information is received from a client device at step 702. This could include, for example, the processor 502 of the device 500 that implements the mapping engine 204 receiving a text message from a client device 208 via a chat client 206. The text message could be received by the processor 502 of the device 500 through the communications unit 506. The text message contains a request for information related to an industrial process control and automation system, such as the system 100.

The text message is parsed to identify the information being requested at step 704. This could include, for example, the processor 502 of the device 500 that implements the mapping engine 204 parsing the text contained in the text message to identify a specific piece of equipment, a specific collection of equipment, or an overall system associated with the message. This could also include the processor 502 using terms contained in the text of the text message to identify one or more specific data values (such as one or more process variables), alarms, or reports associated with the piece of equipment, collection of equipment, or system being requested. This could further include the processor 502 of the device 500 using terms contained in the text of the text message to identify how the user wishes to receive a response, such as via return text message or via email.

One or more queries for the information being requested are transmitted at step 706, and the information being requested is obtained at step 708. This could include, for example, the processor 502 of the device 500 that implements the mapping engine 204 generating one or more queries and transmitting the queries to a historian 142 or other component(s) of the control and automation system 100 or to other data source(s) 210. This could also include the processor 502 of the device 500 receiving one or more responses from the queried component(s) containing the requested information. Any queries to the component(s) of the control and automation system 100 and any responses to those queries could be provided through a chat support application 202.

A natural-language response containing the information being requested is generated at step 710, and the natural-language response is transmitted for delivery to the client device at step 712. This could include, for example, the processor 502 of the device 500 that implements the mapping engine 204 generating another text message containing the natural-language response. This could also include the processor 502 of the device 500 providing the text message with the response to the communications unit 506 for communication to the chat client 206, which can then transmit the text message with the response to the client device 208. Any suitable technique could be used for natural-language generation.

Note that while not shown here, authentication of a user or a client device 208 may be required as part of the method 700 before one or more steps occur in FIG. 7. For instance, the user or the client device 208 could be authenticated after the initial text message is received at step 702 or after the specific data being requested is identified at step 704. This can prevent data from being provided to an unauthorized user or client device.

As shown in FIG. 8, a user's query for information is received at step 802, and a text message containing a request for the information is generated at step 804. This could include, for example, the processor 602 of the device 600 that implements the client device 208 receiving text that is typed into the device 600 or audio data that is converted into text. In some embodiments, the text is received or generated using an app such as SKYPE, FACEBOOK MESSENGER, LINE, SLACK, WHATSAPP, or ALEXA. The text message is transmitted to a chat service at step 806. This could include, for example, the processor 602 of the device 600 providing the message to the transmit processing circuitry 606 for transmission by the RF transceiver 604 via the antenna 602.

A natural-language response containing the information being requested is received at step 808 and displayed at step 810. This could include, for example, the processor 602 of the device 600 that implements the client device 208 receiving another text message containing the response from the receive processing circuitry 610. This could also include the processor 602 of the device 600 presenting the natural-language response on the display 620 of the device 600.

Although FIGS. 7 and 8 illustrate examples of methods 700 and 800 for supporting an interactive chat feature for relaying on-demand information to a user from an industrial process control and automation system, various changes may be made to FIGS. 7 and 8. For example, while each figure shows a series of steps, various steps in each figure could overlap, occur in parallel, or occur any number of times.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
at least one interface configured to receive a text message from a client device, the text message containing a request for information related to an industrial process control and automation system; and
at least one processing device configured to:
parse the text message to identify the information being requested;
transmit one or more queries for the information being requested;
obtain the information being requested; and
generate a natural-language response containing the information being requested;
wherein the at least one interface is further configured to transmit the natural-language response for delivery to the client device.

2. The apparatus of claim 1, wherein the one or more queries comprise at least one query to a historian associated with the industrial process control and automation system.

3. The apparatus of claim 1, wherein the request for information comprises a request for one or more values of one or more process variables associated with the industrial process control and automation system.

4. The apparatus of claim 1, wherein the request for information comprises a request for information identifying a status of specific equipment in the industrial process control and automation system.

5. The apparatus of claim 1, wherein the at least one processing device is configured to obtain the information being requested without interaction with any human operators.

6. The apparatus of claim 1, wherein the at least one processing device is further configured to:
identify second information related to the industrial process control and automation system;
initiate transmission of a second text message to the client device, the second text message asking if the user wishes to receive the second information;
receive a response message from the user indicating whether the user wishes to receive the second information; and
when the response message indicates that the user wishes to receive the second information, initiate transmission of a third text message to the client device, the third text message including the second information.

7. The apparatus of claim 1, wherein:
the at least one processing device is configured to transmit the one or more queries to a support application that interacts with one or more components of the industrial process control and automation system; and
the at least one interface is configured to transmit the natural-language response to a chat client for delivery to the client device.

8. A method comprising:
receiving a text message from a client device, the text message containing a request for information related to an industrial process control and automation system;
parsing the text message to identify the information being requested;
transmitting one or more queries for the information being requested;
obtaining the information being requested;
generating a natural-language response containing the information being requested; and
transmitting the natural-language response for delivery to the client device.

9. The method of claim 8, wherein the one or more queries comprise at least one query to a historian associated with the industrial process control and automation system.

10. The method of claim 8, wherein the request for information comprises a request for one or more values of one or more process variables associated with the industrial process control and automation system.

11. The method of claim 8, wherein the request for information comprises a request for information identifying a status of specific equipment in the industrial process control and automation system.

12. The method of claim 8, wherein the information being requested is obtained without interaction with any human operators.

13. The method of claim 8, further comprising:
identifying second information related to the industrial process control and automation system;
transmitting a second text message to the client device, the second text message asking if the user wishes to receive the second information;
receiving a response message from the user indicating whether the user wishes to receive the second information; and
when the response message indicates that the user wishes to receive the second information, transmitting a third text message to the client device, the third text message including the second information.

14. The method of claim 8, wherein:
the one or more queries are transmitted to a support application that interacts with one or more components of the industrial process control and automation system; and
the natural-language response is transmitted to a chat client for delivery to the client device.

15. A non-transitory computer readable medium containing instructions that, when executed by at least one processing device, cause the at least one processing device to:
receive a text message from a client device, the text message containing a request for information related to an industrial process control and automation system;
parse the text message to identify the information being requested;
initiate transmission of one or more queries for the information being requested;
obtain the information being requested;
generate a natural-language response containing the information being requested; and
initiate transmission of the natural-language response for delivery to the client device.

16. The non-transitory computer readable medium of claim 15, wherein the one or more queries comprise at least one query to a historian associated with the industrial process control and automation system.

17. The non-transitory computer readable medium of claim 15, wherein the request for information comprises a request for one or more values of one or more process variables associated with the industrial process control and automation system.

18. The non-transitory computer readable medium of claim 15, wherein the request for information comprises a request for information identifying a status of specific equipment in the industrial process control and automation system.

19. The non-transitory computer readable medium of claim 15, wherein the information being requested is obtained without interaction with any human operators.

20. The non-transitory computer readable medium of claim 15, further containing instructions that, when executed by the at least one processing device, cause the at least one processing device to:
identify second information related to the industrial process control and automation system;
initiate transmission of a second text message to the client device, the second text message asking if the user wishes to receive the second information;
receive a response message from the user indicating whether the user wishes to receive the second information; and
when the response message indicates that the user wishes to receive the second information, initiate transmission of a third text message to the client device, the third text message including the second information.
